(19) United States
(12) Patent Application Publication
(10) Pub. No.: US 2005/0116954 A1
(43) Pub. Date: Jun. 2, 2005

(54) Method and system for generating a family tree

(76) Inventors: Michael Edward Ripps, Santa Monica, CA (US); Randall Robert Ripps, Scottsdale, AZ (US)

Correspondence Address: MICHAEL J. D'AMELIO, P.O. BOX 1047, 1051 GREAT OAKS DRIVE, SALADO, TX, 76571, US

(21) Appl. No.: 10/726,136

(22) Filed: Dec. 1, 2003

(51) Int. Cl. G06T 11/20

(52) U.S. Cl. 345/440

(57) ABSTRACT

Disclosed is a method and system for generating a graphical output display of a family tree and a graphical output display of a chronological timeline, which are displayed in conjunction with each other. The result is an aesthetically pleasing display, including family member names and dates, as well as colorful images, photographs of family members, and photographs of significant people and events that have taken place at specific dates on the timeline. Dates on the family tree output are synchronized with the dates on the chronological time line.

### FIELD OF THE INVENTION

The disclosed invention relates to a method and system for generating a family tree. More specifically, the disclosed invention relates to a method and system for generating a graphical output display of a family tree in conjunction with a chronological timeline. Displayed information may include names, dates, pictures of family members, and pictures of significant people or events that have taken place at specific dates along the chronological time line.

### BACKGROUND OF THE INVENTION

Genealogy, or the investigation of family history and ancestry, has become of significant interest to people over recent years. Many people have gone to great lengths to collect pedigree information, including names, birth and death dates, marriage information, emigration information, and the like, on their ancestry as far back as information sources will allow. Traditionally, this information may have been sketched out or compiled by hand in chart-form or in a family journal. In recent years however, computers have been used to a greater degree to compile, electronically manipulate, and display such information.

For example, U.S. Pat. No. 6,416,325 B2 to Gross discloses a genealogical analysis tool, namely a computer and computer program to generate a family tree. The thrust of this reference is to overcome the traditional two-dimensional nature of a family tree chart by providing a simulated three-dimensional display of family relationships via a computer monitor. The display of Gross can be rotated on the screen about any of three axes to disclose and clarify family relationships for the user. The information displayed consists of names, dates, and lines representing family relationships, which is typical of any prior art family tree display. Individuals may be targeted, and additional information on an individual may be retrieved, as a secondary operation.

Another example is U.S. Pat. No. 6,570,567 B1 to Eaton, hereby incorporated by reference herein, which discloses a system and method for using a graphical interface for the presentation of genealogical information. This reference shows a family tree system that may be networked to a variety of users via remote terminals for input, use, and display purposes. The output is generally in traditional form, using names, dates, and lines representing relationships among family members, although specific individuals and/or relationships having certain characteristics may be emphasized. As with Gross, additional information on an individual may be retrieved via secondary operation. The useful output is primarily limited to computer monitor display.

Thus there is a need in this area of innovation for an advancement which overcomes the display of basic, mundane charted information, and retrieval and manipulation of such basic information, on a computer resulting in a traditional family tree output display. There is a need for a colorful, graphical family tree output which results in an aesthetically pleasing display, including images, photographs of family members, colorful graphics, and the like, all displayed in conjunction with a chronological timeline the dates of which are synchronized with dates on the family tree, and which includes imagery regarding significant events and people throughout the historical period of the timeline. There is a need for such hardcopy output that will be sought after and displayed by family members for both informative and aesthetic reasons.

### SUMMARY OF THE INVENTION

These and other objects of the present invention will become apparent from a review of the drawings and the following description of the preferred embodiments. The invention disclosed herein is a computer generated family tree output, describing a multigenerational family tree having significant family dates, each date associated with a person included in the family tree. The invention output also describes a chronological timeline including incrementally passing successive dates. The previously recited family dates are shown in synchronicity with the dates on the timeline.

Displayed is information associated with specific persons included in the family tree. This information includes significant dates associated with each specific person. Also displayed is a chronological timeline including gradations indicating a uniform incremental passage of successive dates on the timeline. The significant dates are displayed in synchronicity with corresponding successive dates on the timeline.

Included on the family tree output are a plurality of lifelines, each lifeline corresponding to a person included in the family tree. A marriage between two persons is denoted by merging a portion of their respective lifelines from a marriage beginning date to a marriage ending date. Unknown date indicia, also referred to as an unknown date gradient, indicates a date on a lifeline that is unknown. Common birthday indicia indicates persons with the same birth month and day. Precession of the equinox indicia is displayed in appropriate locations on the timeline.

The computer generated family tree output includes displayed data for persons included in the family tree, specifically graphical images of the persons, which may be displayed in contact with a corresponding lifeline. The chronological timeline may include graphical images displayed at specific dates on the timeline, wherein the graphical images show significant persons, places, or events associated with the specific dates.

Emigration indicia associated with a specific person on the family tree may be included. The chronological timeline is synchronized with the family tree so that the emigration indicia location on the family tree corresponds with a specific date on the chronological timeline thereby revealing a date of emigration. The output may include at least two lifelines displayed in drop-shadow form, which may be sibling lifelines.

Also disclosed is a method for computer generation of a family tree output, including the steps of electronically generating a chronological timeline encompassing a predetermined period of time, inputting data associated with persons to be included in the family tree, electronically generating a family tree based on the data, and displaying the family tree in conjunction with the chronological timeline.

Included in the method may be the step of electronically generating a plurality of lifelines, each lifeline corresponding to a person included in the family tree. Also included may be the step of merging a portion of two lifelines to denote a marriage between two persons associated with the lifelines. The step of electronically generating unknown date indicia indicating a date on a lifeline that is unknown may be included, as may be the step of electronically generating common birthday indicia indicating persons with the same birth month and day, or the step of electronically generating equinox precession indicia to be displayed on the timeline.

Additionally disclosed is a method for computer generation of a family tree output comprising the steps of inputting data associated with a plurality of persons to be included in the family tree, inputting a plurality of graphical images each image associated with a specific person to be included in the family tree, and electronically generating a family tree display based on the data and graphical images. Included may be the steps of electronically generating a chronological timeline comprising gradation dates indicating a uniform incremental passage of time, providing graphical images that correspond with specific gradation dates, associating predetermined graphical images with corresponding gradation dates, and displaying the timeline with the associated images.

The method may include the steps of inputting data on a plurality of persons to be included in the family tree comprising emigration date data having a corresponding emigrated person and a corresponding gradation date on the timeline, generating emigration indicia based on the emigration data, associating the emigration indicia with the corresponding emigrated person, and displaying the emigration indicia on the family tree in synchronicity with the corresponding gradation date on the timeline.

Finally, the method may include the steps of inputting data on at least two persons to be included in the family tree output, generating a lifeline for each person based on the input data, and displaying the lifelines in drop-shadow form.

As used herein, the terms “output” and “display” may be used interchangeably as meaning the product that results from the present invention, as based on the input data, whether in electronic form (i.e., as viewed on a computer monitor screen) or in hardcopy form. The term “common birthday” refers to circumstances in which two or more persons have the same birth month and day. The term “precession of the equinox” refers to the event of a specific astronomical constellation of stars appearing at the horizon on the morning of the spring equinox for a period of about two thousand years, after which the immediately preceding astronomical constellation, as shown on a zodiac chart, appears at that location.

### BRIEF DESCRIPTION OF THE DRAWINGS

FIG. 1A depicts a first data input screen of the present invention.

FIG. 1B depicts an exploded view of a portion of a border shown in FIG. 1A.

FIG. 2 depicts a second data input screen of the present invention.

FIG. 3 depicts a third data input screen of the present invention with a first set of data being input into the computer program.

FIG. 4 depicts the data input screen of FIG. 3 with a second set of data being input into the computer program.

FIG. 5A depicts a fourth data input screen of the present invention.

FIG. 5B depicts an exploded view of the family tree shown in FIG. 5A.

FIG. 6A depicts an embodiment of a family tree showing alternative details.

FIG. 6B depicts a portion of the family tree of FIG. 6A, showing alternative details.

FIGS. 7A, 7B, and 7C depict unknown date gradients of the present invention.

### DETAILED DESCRIPTION OF THE PREFERRED EMBODIMENTS

The present invention is based on the use of computer hardware known in the art in conjunction with a novel computer software program that, along with input data, produces a novel form of family tree output. A vast array of available hardware may be used in accordance with the present invention, not all of which shall be discussed herein as it is generally known to those skilled in the art, and the hardware options for successful practice of the present invention will be readily apparent to those skilled in the art. The focus herein shall be on minimum hardware requirements which may include a desktop or laptop computer with at least 512 megabytes of RAM and at least 20 gigabytes of electronic storage space. These requirements anticipate storage of both the novel software supplied to the user and any electronic image data that the user might add to the program for customization purposes.

A scanner is also desirable, which is able to scan at least 500 dots per inch, and preferably is capable of scanning both opaque and transparent images. To generate aesthetically pleasing hardcopy output of a quality that may be put on display, the use of a 24 inch wide roll feed color printer is highly desirable. Availability on the computer system of additional software, such as Adobe Illustrator® or some equivalent graphics program, Adobe Photoshop® or some equivalent photo sizing and cropping program, and the like is also highly desirable. Both of these systems are offered by Adobe Systems, Inc. of San Jose, Calif. Particular information can be found in the Adobe Photoshop® 7.0 User Guide, © 2002 by Adobe Systems, Inc. and the Adobe Illustrator® 10 User Guide, © 2001 by Adobe Systems, Inc., both hereby incorporated by reference herein. Quark by Quark Technologies, and Corel Paintbox and Corel Drawing software, both by Corel, are other currently available options.

As used herein, the terms “click”, “clicking”, and “double clicking” refer to the standard function of a mouse and electronic pointer on a monitor screen, which are used to take specific actions or accomplish given functions of a computer program.

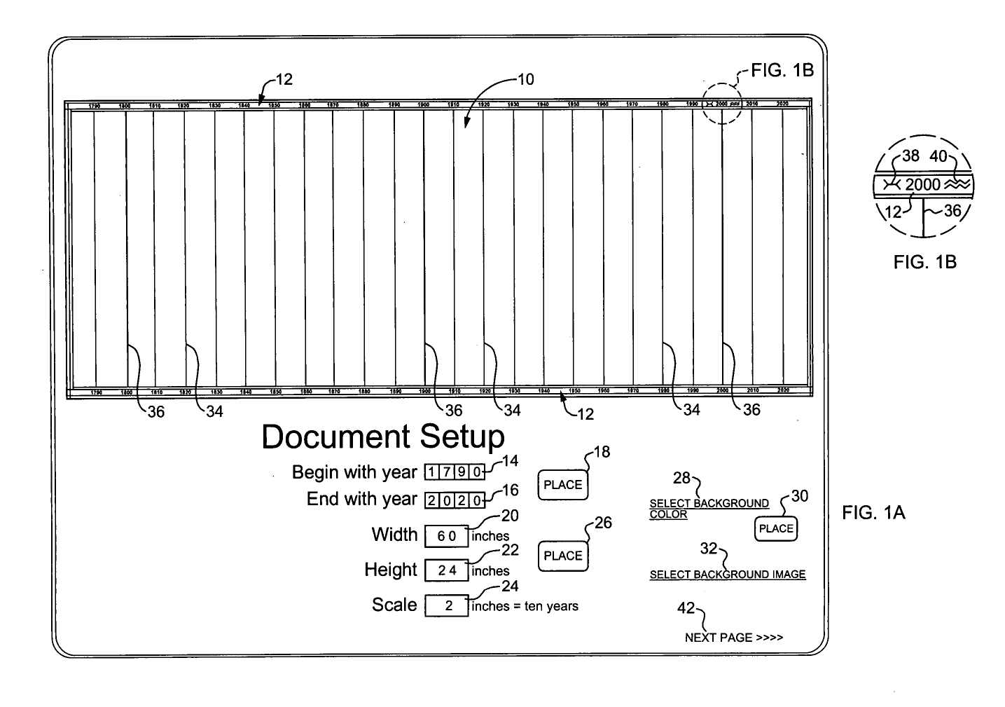

Referring now to the Figures, use of the present invention shall be described beginning with use of the data input screens. Once the present software is loaded into a computer system, an icon is made available on the screen as is customary with computer programs. Double clicking the icon starts the program and displays the first input screen, shown in FIG. 1A. FIG. 1A is referred to as the “Document Setup Screen” and is used to generate the chronological timeline and overall chart upon which the family tree will be displayed. This screen displays a panel 10 having borders 12. Begin year data is input into space 14; the exemplary data in FIG. 1A shows a chart begin year of 1790. End year data is input into space 16; the exemplary data in FIG. 1A shows a chart end year of 2020. After input of begin year and end year data, the user clicks the place key 18 to apply this data to the program.

The user then has control of the size of the hardcopy output of the finished chart. Desired overall chart width is input into space 20, exemplified as 60 inches in FIG. 1A. Overall chart height is input into space 22, exemplified as 24 inches in FIG. 1A. Chart height is directly dependent upon the capacity of the printer being used. The scale of the chart is then entered into space 24, exemplified as 2 inches per decade in FIG. 1A. The user then clicks the place key 26 to apply this data to the program. The result is the timeline shown as panel 10 in FIG. 1A, with the years from 1790 to 2020 set out in 10 year increments in borders 12.

In the event of a conflict between chart width and scale, the program may be arranged so that one of these data entries takes precedence and overrides the other. For example, the overall time span shown in FIG. 1A from 1790 to 2020 is 230 years. If the scale is input as 1 inch per year, the width requirement for display of the entire chart output would be 230 inches. This is much more than the desired width input of 60 inches. The program can be set up so that scale takes precedence over width, or width takes precedence over scale, whichever the user desires.

A background color or background image may be selected for the panel 10. If a background color is desired, the user clicks on the words “select background color” 28 which produces a color palette (not shown). The user selects, or clicks on, the desired background color from the color palette then clicks on place key 30 to confirm the selected background color and apply it to panel 10. If a background image is desired, the user clicks on “select background image” 32 to display a plurality of image options for the background image. The desired background image may then be selected, or clicked, then the user may click on the place key 30 to confirm the selected background image and apply it to panel 10. Background images provided with the computer program may be, for example, a variety of different cloud formations or the like. Users may also scan in custom images for use as background images.

For the sake of clarity of explanation, no background color or image is shown in FIG. 1A. Years are displayed in ten year increments in borders 12 as shown, along with grid lines 34 representing decade gradations. Note that century grid lines 36, displayed at the century marks, are shown in bold. When appropriate, symbols 38 and 40 representing the precession of the equinox may be displayed at the change of millennia. This is more clearly shown in FIG. 1B.

Those who are familiar with astrology and the zodiac symbols will know that the year 2000 marks the beginning of the Age of Aquarius, which was preceded by the Age of Pisces. Thus the Pisces symbol 38 shown prior to the year 2000, and the Aquarius symbol 40 shown after the year 2000 on the chart. This change to a new zodiac sign occurs about every 2000 years. The specific constellation in question appears at the horizon in the morning of the spring equinox. Inclusion of this data on panel 10 provides an additional item of interest to those who are inclined toward astrological information.

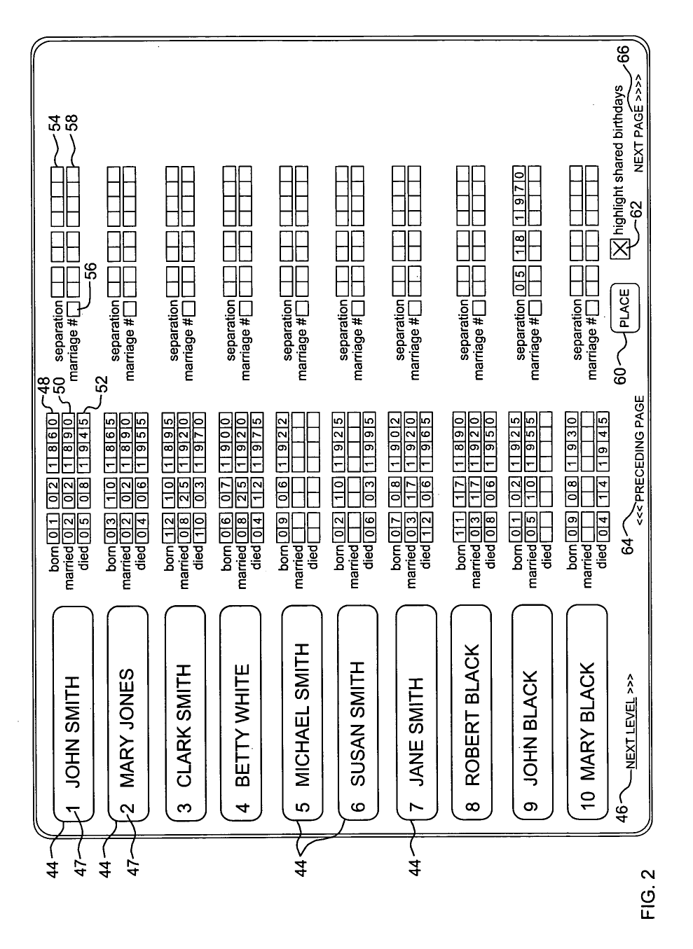

Once the chart is configured as desired by the user, the user clicks on the “next page” symbol 42 shown in FIG. 1A. This results in display of the next input data screen which is shown in FIG. 2.

Referring now to the data input screen of FIG. 2, there is shown name input spaces 44. Although there are only ten name input spaces 44 shown, clicking the “next level” symbol 46 brings up additional data input screens for the addition of more names and their corresponding information. It is anticipated that some family trees may have dozens or hundreds of members, and therefore several of these name input screens may need to be used to complete an entire family tree.

Family names may be put into name input spaces 44 in any order, so long as the number 47 corresponding with a given name input space is identified with that person's input data. For example, the user may click on input space 44 labeled “1” to activate it and input the name “John Smith” as shown. The user is then able to input previously accumulated data associated with “John Smith” in the spaces to the right of this name. John Smith's birth date is input into space 48, his marriage date is input into space 50, and his death date is input into space 52. If he was divorced, his divorce date would be input into space 54. If he was married more than once, the number of the marriage in question would be put into box 56, and the date of that marriage would be input into space 58. For example, if we were inputting data for his second marriage, a “2” would be input into box 56. Any input spaces that do not apply to the person in question would be left blank. At this point, the “place” key 60 would be clicked to apply the input data to the program. Then the name input space labeled “2” would be clicked to activate it, and the process would be repeated for the next family member.

As stated above, once ten names and their associated data are input into this screen, the “next level” symbol 46 would be clicked to bring up a new input screen for additional names. If the “highlight shared birthdays” box 62 is checked, as shown, any family members with the same birth month and day would show up on the family tree with a common birthday indicia or symbol, such as an asterisk or colored circle next to their respective names or birth dates. For example John Smith and John Black have the same birth month and day of January 2. Their birthdates might show up on the family tree with red circles next to them. If two other members of the family have another common birth month and day, their birth dates might show up with a green circle next to them. Any shape, symbol, or device may be used, with or without color coding, so long as the intended purpose is achieved.

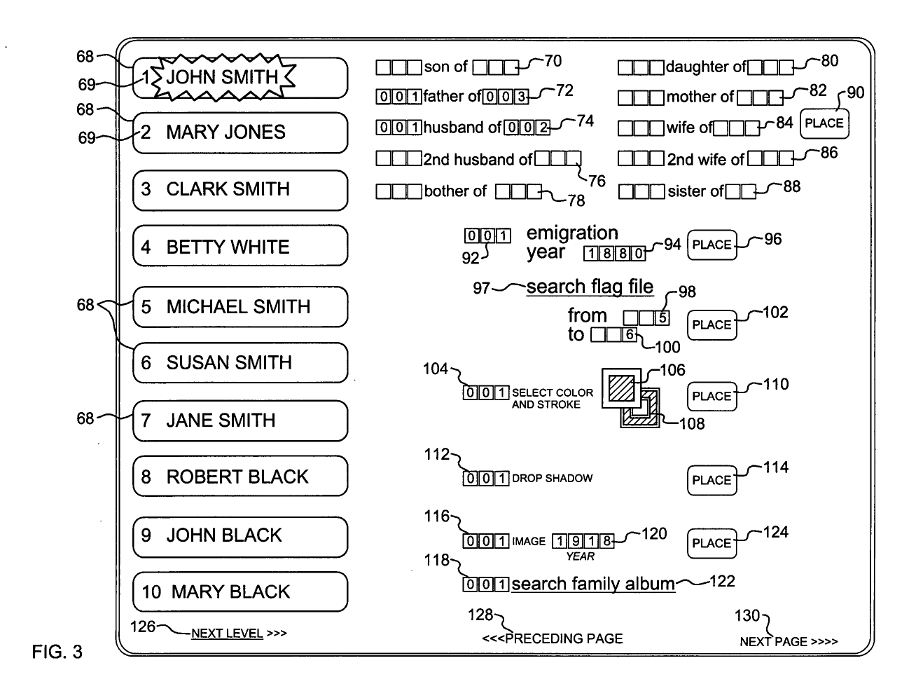

For sake of explanation, the data for each name listed in spaces 44 is shown in FIG. 2. In practice, once the data is input for a specific name and the “place” key 60 is clicked, that person's data is applied to the program and disappears from the input boxes. The process is then repeated for another name. The “preceding page” symbol 64 may be clicked to take the user back to the Document Set Up screen of FIG. 1A, or the “next page” symbol 66 may be clicked to take the user to the data input screen of FIG. 3 once all the family member names and their associated data have been input.

Referring now to FIG. 3, a data input screen which focuses on family relationships and other secondary data is shown. The names that were previously input into the input data screen of FIG. 2 now show up in spaces 68 with their corresponding numbers 69. For example, “John Smith” is again shown in space 68 labeled with the number “1”. What is critical is that all the input data for “John Smith” be associated with the space labeled number “1”. This is accomplished by clicking on this space which activates it, or highlights it as shown, for the input of data.

With space number “1” highlighted, data associated with “John Smith” may now be input. Assuming we do not have information on John Smith's parents, data input space 70 would be left blank. If John Smith is the father of Clark Smith (whose name is in space 68 labeled number “3”), the numbers “001” and “003” would be input into space 72 as shown to create this family relationship on the family tree. If John Smith is the husband of Mary Jones (whose name is in space 68 labeled number “2”), the numbers “001” and “002” would be input into space 74 as shown to create this family relationship on the family tree. Because there is no information to suggested that John Smith has a brother or was remarried, spaces 76 and 78 would be left blank. Input spaces 80 through 88 would be used if the family member in question was female. After this data is input, the “place” key 90 is clicked to apply the data to the program.

If John Smith was an immigrant, his number “001” would be input into space 92 and his emigration year, “1880” in the example, would be input into space 94. “Place” key 96 would then be clicked to apply this data to the program. The “search flag file” symbol 97 would then be clicked to bring up a listing of countries and their flags (not shown). If, for example, John Smith emigrated from Russia to the United States in 1880, the number associated with the Russian flag, in this case “5”, would be input into space 98, and the number associated with the United States flag, in this case “6”, would be input into space 100. “Place” key 102 is then clicked to apply this data to the program. The resultant output on the family tree will be described in detail below.

Each family member is depicted on the family tree as a lifeline, or a rectangular bar, as will be described in detail below. Inputting John Smith's number “001” into space 104 allows the selection of a color and other graphics for his lifeline. Clicking on box 106 brings up a color palette (not shown) which allows the selection of a color for John Smith's lifeline. Clicking on box 108 allows the user to choose to show John Smith's lifeline outlined in bold which may be desirable to highlight certain persons or certain relationships. If, for example, the user desires that all the family members which make up the patriarchal lineage should be emphasized on the family tree, box 108 may be clicked to outline John Smith's lifeline in bold, as would all the lifelines associated with his descendant males. Clicking the “place” key 110 applies this data to the program. Note that boxes 106 and 108 are shown overlapped in FIG. 3, as this is how they appear in Adobe programs.

John Smith's lifeline may also be shown in “drop shadow” form, or in other words with a three dimensional effect as will be further described in detail below. If this is desired, his number “001” is input into space 112 and the “place” key 114 is clicked to apply this data to the program. Also, photographs of John Smith at various points in his life may be displayed on the family tree at appropriate points on his lifeline. If this is desired, his number “001” is input into spaces 116 and 118, the desired picture year is input into space 120, in this example 1918, and the “search family album” symbol 122 is clicked. This brings up a selection of previously input images of John Smith for the year 1918, which may be displayed with captions, including for example name and date. The user may then select an image, then click the “place” key 124 to apply the image to the program. The image will be shown at a point on John Smith's lifeline associated with the year 1918, as will be described in more detail below. The user has the discretion, however, to move images around on the final family tree to his or her liking. Additionally, the user may click the “search family album” symbol 122 and browse through the offered images and select desired images at will for placement on the family tree.

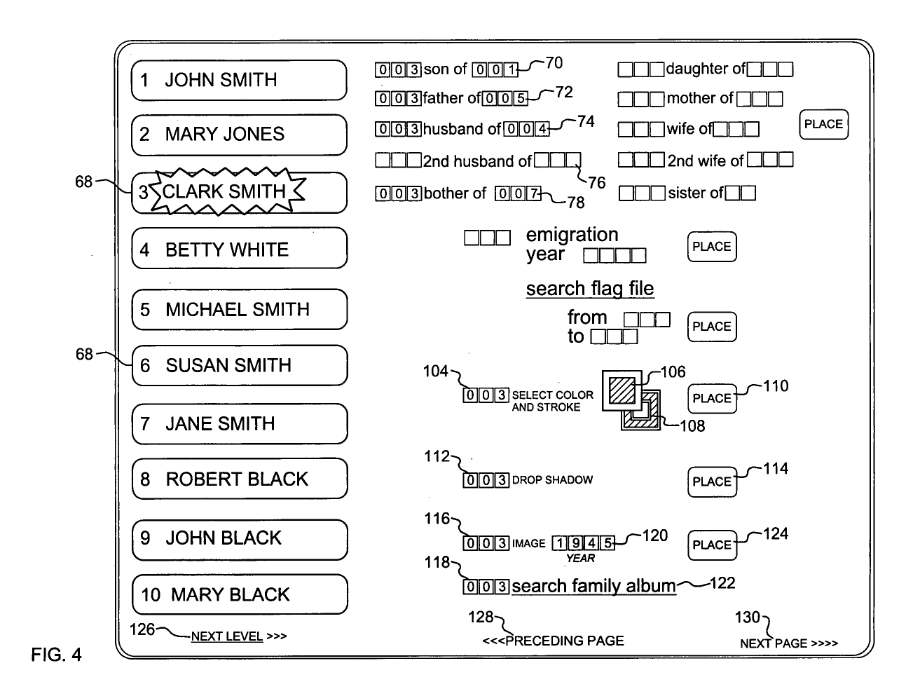

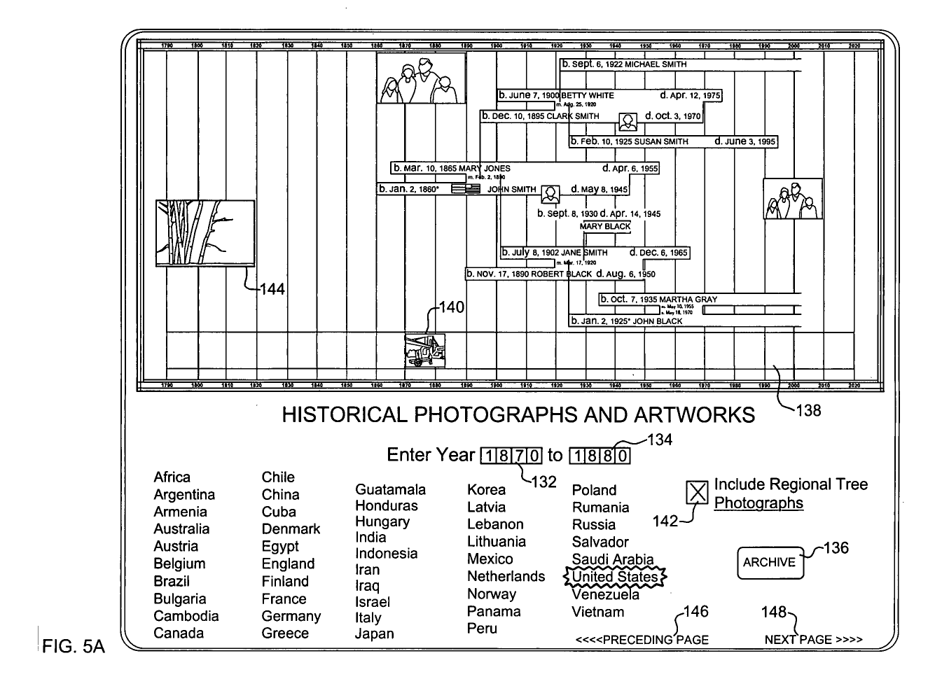

The “next level” symbol 126 allows similar data to be input for additional names on additional pages of this input screen. The “preceding page” symbol 128 takes the user back to the input screen of FIG. 2. The “next page” symbol 130 takes the user to the input screen of FIG. 5. However, we shall first consider the data input procedure just described for another family member by reference to FIG. 4.

In FIG. 4, note that the name “Clark Smith” in name input space 68 labeled with the number “3” is highlighted. This activates data input for Clark Smith. His associated number “003” is input into spaces 70, 72, 74, and 78 as shown and as previously described above. Note that the information provides that he is the son of John Smith, the father of Michael Smith, the husband of Betty White, and the brother of Jane Smith. If he is also the father of Susan Smith in space 68 labeled with the number “6”, the program will use simple logic to determine this fact if Susan Smith is input into the program as the daughter of Betty White and born during Betty White's marriage to Clark Smith. It will also determine this if Susan Smith is input as the sister of Michael Smith who was previously identified as Clark Smith's son, so long as Susan Smith was born during the marriage of Betty White and Clark Smith. In other words, the program is capable of taking data associated with a variety of family members and using simple logic to extrapolate family relationships that have not been directly identified by direct data input.

Consider an additional example in simple logic form. A family consists of members A, B, C, D, E, F & G. If B is identified as the wife of A on A's data input screen, and C is identified as the son of A on A's data input screen, and D is identified as the son of B on B's data input screen, and E is identified as the sister of C on C's data input screen, and F is identified as the brother of D on D's data input screen, and G is identified as the sister of E on E's data input screen, and all the children were born during the marriage of A and B, then the program will extrapolate these relationships and recognize this as a nuclear family and display it as such via lifelines, and showing appropriate birth dates, death dates, marriage dates, etc. as will be described in further detail below.

Data input for lifeline color and outline of the lifeline in bold, drop shadow function, and selection of images works as described in the example above. After this data is input for all family members named in the program, the “next page” symbol 130 is clicked to reach the data input screen of FIG. 5A.

Referring now to FIG. 5A, this data input screen displays the previously constructed timeline chart with the fully constructed family tree, which is shown in greater detail in FIG. 5B. This data input screen allows additional images, in the form of historical photographs and artworks, to be added to the program output. The user may view a selection of images for a specific historical period of time by inputting a beginning year into space 132, the year 1870 being shown in the example, and an ending year into space 134, the year 1880 being shown in the example. The user may then click on any one of the listed countries, then by clicking on the “archive” key 136 a selection of images for the selected time period and pertaining to the selected country will be brought up on the screen. This selection of images may be displayed with captions, including for example names, dates, places, etc. The user may then select an image and place it on the chart in the desired location.

It should be noted that the listing of countries here is exemplary, and many more countries would be added to the program and available on this data input screen or on additional pages of this screen which would be accessible through some sort of “next level” icon, similar to what was described above in conjunction with FIGS. 2, 3, and 4. Also, the national flags could accompany country names as small thumbnail images, either just for reference or as activation icons of some sort.

For example, if the user wants to put a picture of the Brooklyn Bridge on the timeline image ribbon 138 at about the year of its construction, the user would input the exemplary data, highlite the United States (as shown), select the appropriate image from those that are made available, and that image would be placed at the appropriate point on ribbon 138, herein shown as image 140. A check mark placed in box 142 allows a selection of regional tree images, or other country-related symbols or pictures, to be brought up when “archive” key 136 is clicked. Such images may be placed at various locations on the chart to indicate countries of significance of the family at that stage in history. For example, image 144 represents birch trees which are associated with Russia. If the family originated in Russia, this would be an appropriate picture to depict at the beginning of the family tree.

With specific reference to image 144 in FIG. 5A, a particularly aesthetically pleasing effect may be provided by beginning the first lifeline in the family tree (i.e., the lifeline of the oldest ancestor displayed on the tree) with such an image. The image 144 may be incorporated into the beginning of this person's lifeline, and the image may gradually blend with and be shaded into the color of the lifeline. The lifeline would be the same height as the image, and would stem from the image using a color gradient feature of the present invention, as discussed in more detail below. An example of such a gradient tool is provided in the Adobe software via an opacity mask function.

Additionally, a selection of family portraits and group pictures may be made available to use at various locations on the chart, particularly to fill in blank space on the chart. Although the program will display images at an appropriate point on ribbon 138 corresponding to an image date, the user always has the discretion to move images around on the chart via software capability. It is anticipated that a plurality of images would be shown on ribbon 138 for historical perspective, as would a plurality of family photos be shown on and near the lifelines of the family tree. Such output is particularly aesthetically appealing, especially when the output is in full color.

We also anticipate that any image on the family tree output, when displayed on a monitor screen, may be activated to display further data, such as historical news, archived information, immigration data, etc. Such activation may also display a data stream in the form of video and/or audio. For example, an image of a family member may serve as a link to a digitized clip of a home video of that person that has been stored into the program. The image, when double clicked, would call up and begin the data stream which would show up on the monitor as a motion picture, with or without audio. As understood by those skilled in the art, such a function would be limited to the output display on a monitor screen.

As well, graphic means for distinguishing among various family relationships, such as cousins, second cousins, step-brothers and sisters, adoptive relationships, etc. may be supplied, as may a morphing visual stream of the growth and aging of any individual on the family tree. It is also possible to provide for the program to gradually unfold a completed family tree on a computer monitor, from beginning to end, so that the user can watch the generations and lifelines unfold through the years, at a rate of perhaps 100 years in 4 or 5 minutes time.

Also, the program may provide for a system by which all images, whether provided with the program or subsequently input into the program by the user, are associated with some means of identification, for example a number and perhaps also an identifying title, the name of a person in the image, the image year, and similar information. This would be combined with means to allow the user to print out a list of all image numbers with associated titles, or other information, as an index of the image archives.

Clicking the “preceding page” symbol 146 takes the user back to the input data screen of FIG. 4, and clicking the “next page” symbol 148 takes the user to a screen that displays the finished chart complete with family tree, timeline, family images, and historical images, which is now ready for print-out in hard copy form. The family tree shown in FIG. 5A warrants additional discussion, and an exploded view of the family tree is shown in FIG. 5B for clarity of detail.

As shown in FIG. 5B, each person is depicted as a lifeline 150, having a left end 152 which corresponds to a birth date. Note that the birth date of any given lifeline 150 is synchronized with the appropriate date on the timeline chart. Regarding deceased persons, the right end 154 corresponds to a death date. Note that the death date of any given lifeline 150 is synchronized with the appropriate date on the timeline chart. In fact, all events shown on lifelines that have a date associated with them are in synchronicity with dates on the timeline chart. The photograph of John Smith 156 was taken in 1918, thus its location on John Smith's lifeline with respect to the timeline chart. It is anticipated that many, many more images of persons on the family tree would be displayed than are shown in the simple example of FIG. 5B.

Marriage is denoted by the merging of two lifelines from the date of the marriage to either the death date of the first spouse to die or the date of separation. The marriage between John Smith and Mary Jones is shown as a merging of their respective lifelines at a point 158 corresponding to the year 1890 on the timeline chart. Their marriage ended when John Smith died in 1945, as shown by right end 154 of John Smith's lifeline. Note that John Black's marriage ended in 1970 when he and Martha Gray were divorced, as depicted by the de-merging of their lifelines at point 160.

Family members who are still living at the time of creation of the family tree are depicted in this example by an open right end 162 on their lifelines. Asterisks 164a and 164b denote common birth month and day between individuals, in this case between John Smith and John Black. Emigration indicia 166 denotes a person who emigrated from one country to another. In this example, the Russian flag on the left indicates the country emigrated from, and the United States flag on the right indicates the country emigrated to. The flags are centered on the emigration date, which is the year 1890 in this example. Note also that information 168 (here associated with Mary Black's lifeline) may be placed outside of a person's lifeline when space within a lifeline is restricted. Again, the user has discretion and may edit the placement of information and images on the final family tree output.

The birthdates of children of a marriage shown in the family tree are associated with vertical lines 170. These vertical lines stem from the area in which a couple's lifelines have merged to show a marriage relationship, and extend to the child's lifeline at a left edge of the lifeline indicating the year of the child's birth. As stated previously, family photographs 172 may be inserted on the chart in various locations for aesthetic and informational appeal.

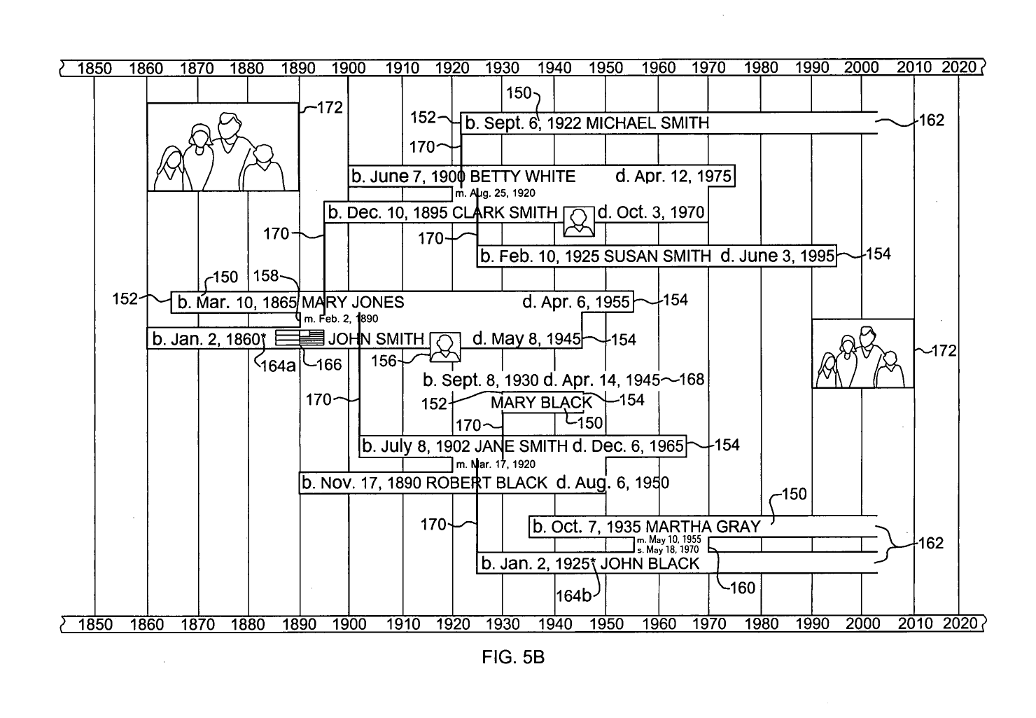

Referring now to FIG. 6A, additional detail of the present invention shall be discussed. Shown in FIG. 6A are the lifeline 174 of a husband, lifeline 176 of husband's first wife, and lifeline 178 of husband's second wife. Note that the first marriage begins at point 180 where lifelines 174 and 176 merge, as discussed above. This first marriage ends at point 182 where lifelines 174 and 176 de-merge, also as discussed above. Subsequent to point 182, which represents a divorce, point 184 represents husband's second marriage by the merger of lifelines 174 and 178. This second marriage ends when husband dies on a date represented by the right end 186 of his lifeline.

Three children of the first marriage stem from vertical line 188 which is placed at the birth date of lifeline 190. Sibling lifelines 192 and 194 then may be represented as shown with their left ends 196, 198, and 200 representing their respective birth dates which are aligned with the appropriate dates on the timeline chart, as discussed above. This is an alternate method of displaying children of a marriage and sibling relationships when, for example, space considerations require such alternate display. This method of displaying children and siblings becomes particularly important in later generations when the family tree becomes more crowded, as it saves space and allows family members to be clustered about their parents and other close relatives to preserve clarity of relationships and the overall display.

Note there is a child of the second marriage represented by lifeline 202 which is shown stemming from and wholly inside lifeline 178 (the mother's lifeline) from a point within the area where lifelines 174 and 178 merge. This is another alternate method of displaying children of a marriage when, for example, space considerations require such alternate display. Lifeline 202 could also have been shown stemming from lifeline 174 (the father's lifeline), or anywhere within the area of the parents' lifelines.

Note that the open right ends of the various lifelines in FIG. 6A denote that these family members are still alive. Note also that these lifelines are shown in “drop shadow” form 204; that is, a shadow effect has been added on the left and lower sides of the lifelines to produce a three-dimensional effect. In particular, lifelines 190, 192, and 194 are shown in drop shadow form and slightly overlapping each other which adds to the three-dimensional effect. This drop shadow method is used to highlight particular lifelines on the family tree. For example, the user may wish that all family members in a patriarchal lineage be displayed in drop shadow form to highlight that patriarchal lineage. Alternately, the user may wish to use this method to highlight a matriarchal lineage, or perhaps one particular branch of the family on the tree.

Referring now to FIG. 6B, an alternative embodiment of lifeline 202 of FIG. 6A will be discussed. Child's lifeline 2020 is shown stemming from lifeline 1780 to the right of the merged area of parents' lifelines 1740 and 1780. Lifeline 2020 may be shown in conjunction with an image 2022 of the child, as a child or as an adult, merged into the lifeline as shown. Image 2022 may begin lifeline 2020 at its left end, corresponding to the person's birth date. An open left end 2024 may be depicted, with the color of the parental lifeline 1780 merging into and blending with the color of lifeline 2020 for a pleasing aesthetic effect.

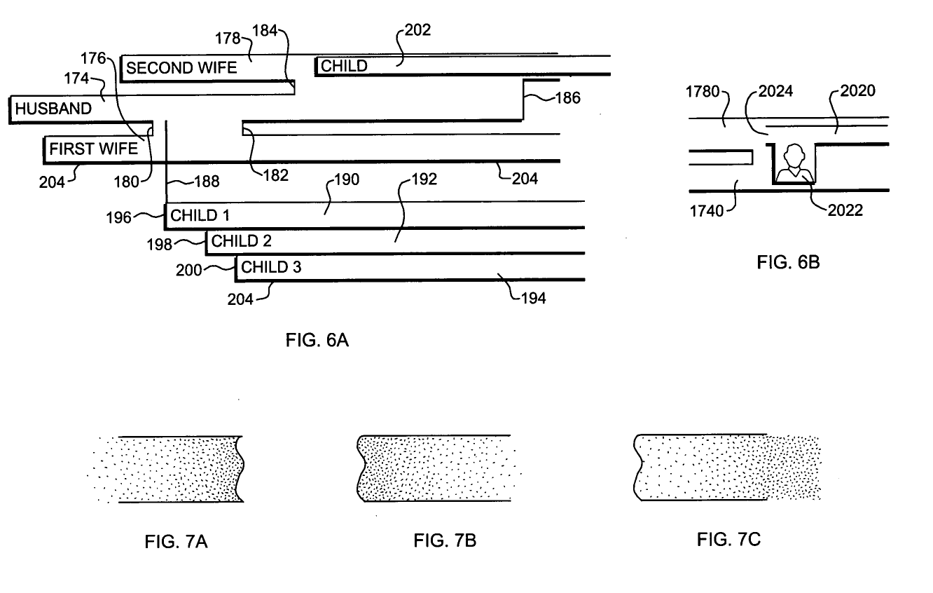

Referring now to FIGS. 7A through C, the concept of an “unknown date gradient” shall be discussed. When a person's date of birth is unknown the left edge of their lifeline may be displayed as shown in FIG. 7A, a gradual tapering from white or the background color on the chart into the color of the lifeline, to represent such unknown birth date. When a person is still living an alternative to an open right end on their lifeline is shown in FIG. 7B wherein the color of a lifeline gradually tapers off to white or the background color of the chart; this method has a more aesthetic appeal than simply leaving a lifeline open-ended, especially with full color display. When a date of death is unknown, the method of FIG. 7C may be used, wherein the color of a lifeline gradually tapers into darker shades of gray at its right end. Similar methods may be used when, for example, the dates of marriage or separation are unknown, or when any other dates associated with family members are unknown.

Having thus described exemplary embodiments of the present invention, it should be noted by those skilled in the art that the above disclosures are exemplary only and that various other alternatives, adaptations, and modifications may be made within the scope of the invention. Accordingly, it is to be understood that the present invention is not limited to the precise construction as shown in the drawings and described hereinabove.

1. A computer generated family tree output comprising:
a multigenerational family tree further comprising significant family dates, each date associated with a person included in the family tree; and
a chronological timeline further comprising incrementally passing successive dates;
wherein the family dates are synchronized with the dates on the timeline.

2. The computer generated family tree output of claim 1, further comprising a plurality of lifelines, each lifeline corresponding to a person included in the family tree.

3. The computer generated family tree output of claim 2, wherein a marriage between two persons is denoted by merging a portion of their respective lifelines from a marriage beginning date to a marriage ending date.

4. The computer generated family tree output of claim 2, further comprising unknown date indicia indicating a date on a lifeline that is unknown.

5. The computer generated family tree output of claim 2, further comprising common birthday indicia indicating persons with the same birth month and day.

6. The computer generated family tree output of claim 2, further comprising equinox precession indicia displayed on the timeline.

7. A computer generated family tree output comprising:
displayed information associated with a specific person included in the family tree, the information further comprising significant dates associated with the specific person;
a chronological timeline comprising gradations indicating a uniform incremental passage of successive dates on the timeline; wherein the significant dates are synchronized with corresponding successive dates on the timeline.

8. The computer generated family tree output of claim 7, further comprising a plurality of lifelines, each lifeline corresponding to a person included in the family tree.

9. The computer generated family tree output of claim 8, wherein a marriage between two persons is denoted by merging a portion of their respective lifelines from a marriage beginning date to a marriage ending date.

10. The computer generated family tree output of claim 8, further comprising unknown date indicia indicating a date on a lifeline that is unknown.

11. The computer generated family tree output of claim 8, further comprising common birthday indicia indicating persons with the same birth month and day.

12. The computer generated family tree output of claim 8, further comprising equinox precession indicia displayed on the timeline.

13. A computer generated family tree output comprising:
displayed data for persons included in the family tree, the displayed data further comprising graphical images of the persons.

14. The computer generated family tree output of claim 13, wherein the graphical image of a person is displayed in contact with the person's lifeline.

15. A computer generated family tree output comprising:
a chronological timeline further comprising graphical images displayed at specific dates on the timeline, wherein the graphical images show significant events associated with the specific dates.

16. A computer generated family tree output comprising:
emigration indicia associated with a specific person on the family tree; and
a chronological timeline synchronized with the family tree so that the emigration indicia location on the family tree corresponds with a specific date on the chronological timeline thereby revealing a date of emigration.

17. A computer generated family tree output comprising:
at least two lifelines displayed in drop-shadow form.

18. The computer generated family tree output of claim 17, wherein the at least two lifelines are sibling lifelines.

19. A method for computer generation of a family tree output comprising the steps of:
electronically generating a chronological timeline, the timeline encompassing a predetermined period of time;
inputting data associated with persons to be included in the family tree;
electronically generating a family tree based on the data; and
displaying the family tree in conjunction with the chronological timeline.

20. The method of claim 19, further comprising the step of electronically generating a plurality of lifelines, each lifeline corresponding to a person included in the family tree.

21. The method of claim 20, further comprising the step of merging a portion of two lifelines to denote a marriage between two persons associated with the lifelines.

22. The method of claim 20, further comprising the step of electronically generating unknown date indicia indicating a date on a lifeline that is unknown.

23. The method of claim 20, further comprising the step of electronically generating common birthday indicia indicating persons with the same birth month and day.

24. The method of claim 20, further comprising the step of electronically generating equinox precession indicia displayed on the timeline.

25. A method for computer generation of a family tree output comprising the steps of:
electronically generating a chronological timeline comprising gradation dates indicating a uniform incremental passage of time;
inputting data associated with persons to be included in the family tree, the data further comprising specific dates;
electronically generating a family tree based on the data; and
displaying the family tree in conjunction with the chronological timeline so that the specific dates are synchronized with the gradation dates.

26. The method of claim 25, further comprising the step of electronically generating a plurality of lifelines, each lifeline corresponding to a person included in the family tree.

27. The method of claim 26, further comprising the step of merging a portion of two lifelines to denote a marriage between two persons associated with the lifelines.

28. The method of claim 26, further comprising the step of electronically generating unknown date indicia indicating a date on a lifeline that is unknown.

29. The method of claim 26, further comprising the step of electronically generating common birthday indicia indicating persons with the same birth month and day.

30. The method of claim 26, further comprising the step of electronically generating equinox precession indicia displayed on the timeline.

31. A method for computer generation of a family tree output comprising the steps of:
inputting data associated with a plurality of persons to be included in the family tree;
inputting a plurality of graphical images, each image associated with a specific person to be included in the family tree; and
electronically generating a family tree display based on the data and graphical images.

32. A method for computer generation of a family tree output comprising the steps of:
electronically generating a chronological timeline comprising gradation dates indicating a uniform incremental passage of time;
providing graphical images that correspond with specific gradation dates;
associating predetermined graphical images with corresponding gradation dates; and
displaying the timeline with the associated images.

33. A method for computer generation of a family tree output comprising the steps of:
electronically generating a chronological timeline comprising gradation dates
indicating a uniform incremental passage of time;
inputting data on a plurality of persons to be included in the family tree, the data
comprising emigration date data having a corresponding emigrated person and a
corresponding gradation date on the timeline;
generating emigration indicia based on the emigration data;
associating the emigration indicia with the corresponding emigrated person; and
displaying the emigration indicia on the family tree in synchronicity with the
corresponding gradation date on the timeline.

34. A method for computer generation of a family tree output comprising the steps of:
inputting data on at least two persons to be included in the family tree output;
generating a lifeline for each person based on the input data; and
displaying the lifelines in drop-shadow form.

35. The method of claim 34, wherein the persons are siblings.
